(19) United States
(12) Patent Application Publication
(10) Pub. No.: US 2015/0278745 A1
(43) Pub. Date: Oct. 1, 2015

(54) System for Analyzing Contracts and Supplier's Performance

(71) Applicants: SACHIN SHARMA, MUMBAI (IN); CHITRESH JAIN, MUMBAI (IN)

(72) Inventors: SACHIN SHARMA, MUMBAI (IN); CHITRESH JAIN, MUMBAI (IN)

(21) Appl. No.: 14/738,855

(22) Filed: Jun. 13, 2015

Related U.S. Application Data
(63) Continuation-in-part of application No. 14/498,676, filed on Sep. 26, 2014.
Application No. 14/498,676 is a continuation-in-part of application No. 13/687,578, filed on Nov. 28, 2012, now abandoned.

(30) Foreign Application Priority Data
Jul. 31, 2012 (IN) 2192/MUM/2012

(51) Int. Cl. G06Q 10/06; G06Q 30/06

(52) U.S. Cl. CPC G06Q 10/06393; G06Q 30/0609

(57) ABSTRACT

A system and method for analyzing and taking actions pertaining to contracts and supplier's performance in a procurement process, including: a module containing a database of contracts of suppliers; and a module adapted for measuring, analyzing and managing the performance of a supplier. The system and method allows the viewing of a supplier performance report corresponding to the specific contract selected, as well the viewing of contracts corresponding to the specific supplier selected. The system and method also allows a user to make a decision regarding the renewal or termination of the contract with a specified supplier, for example, based on the performance report of the supplier.

### CROSS-REFERENCE TO RELATED APPLICATION

The instant application is a continuation-in-part of U.S. patent application Ser. No. 14/498,676, filed Sep. 26, 2014, pending, which is a continuation-in-part of U.S. patent application Ser. No. 13/687,578, filed Nov. 28, 2012, abandoned, and claims priority to Indian Patent Application Ser. No. 2192/MUM/2012, filed Jul. 31, 2012, the entire specifications of all of which are expressly incorporated herein by reference.

### FIELD OF THE INVENTION

The present invention generally relates to the procurement of goods and services, and more specifically to a system for analyzing and taking actions pertaining to contracts and supplier's performance in the procurement process.

### BACKGROUND OF THE INVENTION

In the process of procurement of goods and services, the performance of the supplier, as measured against the contract, plays a very important role. U.S. Patent Application Publication No. 2005203821 describes a system to provide a comprehensive contract and supplier management tool for goods and services procurement of an enterprise. The system includes an information database of suppliers and contracts used by goods and services procurement personnel, but it does not help in making decision about renewal or termination of the contract of a specific supplier. U.S. Patent Application Publication No. 2009182606 describes a system and method to evaluate supplier performance against the terms of a contract. U.S. Patent Application Publication No. 2003090509 describes methods and systems for documenting and evaluating the performance of a global supplier base. U.S. Patent Application Publication No. 2008255896 describes a system and method for aiding a buyer to create a supplier scorecard. However, all of the afore-mentioned conventional systems suffer from several deficiencies and are not entirely satisfactory.

Accordingly, there exists a need for new and improved systems for analyzing and taking actions pertaining to contracts and supplier's performance in the procurement process that overcome at least one of the aforementioned problems.

### SUMMARY OF THE INVENTION

One object of the present invention is to provide a system for analyzing and taking actions pertaining to contracts and supplier's performance in the procurement process.

Another object of the present invention is to provide a system that facilitates making a decision regarding the renewal or termination of the contract with a specified supplier based on the performance of the supplier.

In accordance with the general teachings of the present invention, a system is provided for analyzing and managing contract and supplier performance in the procurement process. By way of a non-limiting example, based on the performance report of the supplier, it allows a user to make a decision regarding the renewal or termination of the contract with respect to a specified supplier.

In accordance with one embodiment of the present invention, a system is provided that contains an integration of a contact module and a supplier performance management (“SPM”) module, allowing the user to view the performance report of the supplier, present in the SPM module in connection to any contract being selected from the contract module. Based on the performance report of the supplier, it allows a user to make a decision regarding the renewal or termination of the contract with respect to a specified supplier. The system of the present invention also allows the user to view the contracts present in the contract module in relation to a specific supplier being selected from the SPM module. This further allows the user to decide about any related contracts for poor performing suppliers, which further provides access to see the contract's terms in relation to the service level agreement (“SLA”) or termination.

In accordance with a first illustrative embodiment of the present invention, a system for taking action based on supplier contract and performance is provided, wherein there is an interconnection of at least one configurable and namable business process element, comprising:

a host computer system;

at least one database component associated with the host computer system;

a communication interface for accessing the host computer system from a plurality of remote input/output devices to manage action based on a supplier contract and performance for the business process element;

a processor unit operably associated with the host computer system; and

a computer readable medium storing instructions executable by the processor unit, the computer readable medium comprising:

a contract module containing a database of supplier contracts; and

a supplier performance module operably associated with the contract module;

wherein the supplier performance module is adapted for measuring, analyzing and/or managing the performance of a supplier;

wherein the system is adapted for analyzing and taking actions pertaining to contracts and supplier's performance in a procurement process;

wherein the system is adapted for viewing a supplier performance report corresponding to a specific contract selected for an action;

wherein the system is adapted for viewing the contracts and its clauses based on a level of performance corresponding to a specific supplier.

In accordance with a first aspect of the first illustrative embodiment, the supplier performance module measures the performance of the supplier by defining key performance indicators and associating the key performance indicators with a scorecard, wherein the key performance indicators are a set of questions capturing the scores pertaining to the supplier for these questions.

In accordance with a second aspect of the first illustrative embodiment, the system further comprises an alert system for generating an alert depending on the score of the supplier's performance.

In accordance with a third aspect of the first illustrative embodiment, the system is adapted for mapping of specific key performance indicators of the supplier in the supplier performance module based on the type of alert generated by the system.

In accordance with a fourth aspect of the first illustrative embodiment, the supplier performance module comprises a system containing decision rules which link to contract clauses based on the level of performance indicated in the supplier performance report.

In accordance with a fifth aspect of the first illustrative embodiment, the system contains decision rules adapted to link to a termination clause and/or penalty clause in the contract of a supplier showing a poor, average and/or good performance level in the supplier performance report.

In accordance with a sixth aspect of the first illustrative embodiment, the system contains decision rules adapted to link to a renewal clause in the contract of the supplier showing a high performance level in the supplier performance report.

In accordance with a seventh aspect of the first illustrative embodiment, the supplier performance module facilitates the creation of new key performance indicators and/or modification of existing key performance indicators, wherein the supplier performance module further facilitates the assignment of new scores.

In accordance with a second illustrative embodiment of the present invention, a method for taking action based on supplier contract and performance is provided, wherein there is an interconnection of at least one configurable and namable business process element, comprising the steps of:

providing a host computer system;

providing at least one database component associated with the host computer system;

providing a communication interface for accessing the host computer system from a plurality of remote input/output devices to manage action based on a supplier contract and performance for the business process element;

providing a processor unit operably associated with the host computer system; and

providing a computer readable medium storing instructions executable by the processor unit to perform the steps of:

creating a database of contracts of suppliers or adding contracts of suppliers to the existing database in a contract module; and

measuring, analyzing and/or managing the performance of a supplier in a supplier performance module;

wherein the method is adapted for viewing a supplier performance report corresponding to the specific contract being selected for an action;

wherein the method is adapted for viewing contracts and its clauses based on the level of performance corresponding to the specific supplier being selected.

In accordance with a first aspect of the second illustrative embodiment, the supplier performance module measures the performance of a supplier by defining key performance indicators and associating the key performance indicators with a scorecard, wherein the key performance indicators are a set of questions capturing the scores pertaining to the supplier for these questions.

In accordance with a second aspect of the second illustrative embodiment, the method further comprises the step of generating an alert depending on the score of the supplier's performance.

In accordance with a third aspect of the second illustrative embodiment, the method is adapted for mapping of specific key performance indicators of the supplier in the supplier performance module based on the type of alert generated by the system.

In accordance with a fourth aspect of the second illustrative embodiment, the method further comprises the step of creating decision rules which link to contract clauses based on the level of performance indicated in the supplier performance report.

In accordance with a fifth aspect of the second illustrative embodiment, wherein the step of creating decision rules is adapted to link to a termination clause and/or penalty clause in the contract of the supplier showing poor, average or good performance levels in the supplier performance report.

In accordance with a sixth aspect of the second illustrative embodiment, wherein the step of creating decision rules is adapted to link to a renewal clause in the contract of the supplier showing high performance level in the supplier performance report.

In accordance with a seventh aspect of the second illustrative embodiment, the method facilitates the creation of new key performance indicators and/or the modification of existing key performance indicators, wherein the method further facilitates the assignment of new scores.

For example, the user could manage an element of the system and method for taking action based on supplier contract and performance on the handheld mobile device (e.g., cellular phone, smartphone, PDA, laptop computer, tablet computer, and/or any other like device that is selectively operable to communicate with the host computer system (or component thereof) through a wired and/or wireless connection) for which management needs to be done for.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The invention will now be described in relation to the accompanying drawings in which:

FIG. 1 illustrates a flowchart of the primary steps in a system for analyzing and taking actions pertaining to contracts and supplier's performance in the procurement process, in accordance with a first embodiment of the present invention;

FIGS. 2a-2d illustrate computer screenshots demonstrating several features of a searching system of a contract module of a system for analyzing and taking actions pertaining to contracts and supplier's performance in the procurement process, in accordance with a second embodiment of the present invention; and

FIGS. 3a-3f illustrate computer screenshots demonstrating several features of a scoring system of a supplier performance management module of a system for analyzing and taking actions pertaining to contracts and supplier's performance in the procurement process, according to a third embodiment of the present invention.

The same reference numerals refer to the same parts throughout the various Figures.

### DETAILED DESCRIPTION OF THE INVENTION

The following description of the preferred embodiment(s) is merely exemplary in nature and is in no way intended to limit the invention, or uses.

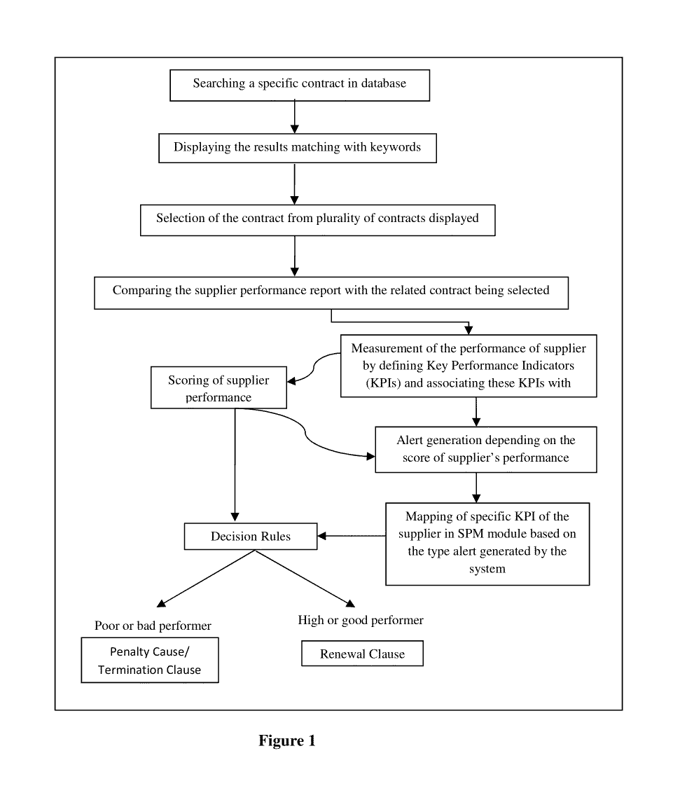

Referring to FIG. 1, a system is provided containing an integration of a contract module and a SPM module for analyzing and taking actions pertaining to contracts and supplier's performance in the procurement process. The system may be adapted for viewing a supplier performance report corresponding to the specific contract being selected for an action, the system further adapted for viewing contracts and its clauses based on the level of performance corresponding to the specific supplier being selected.

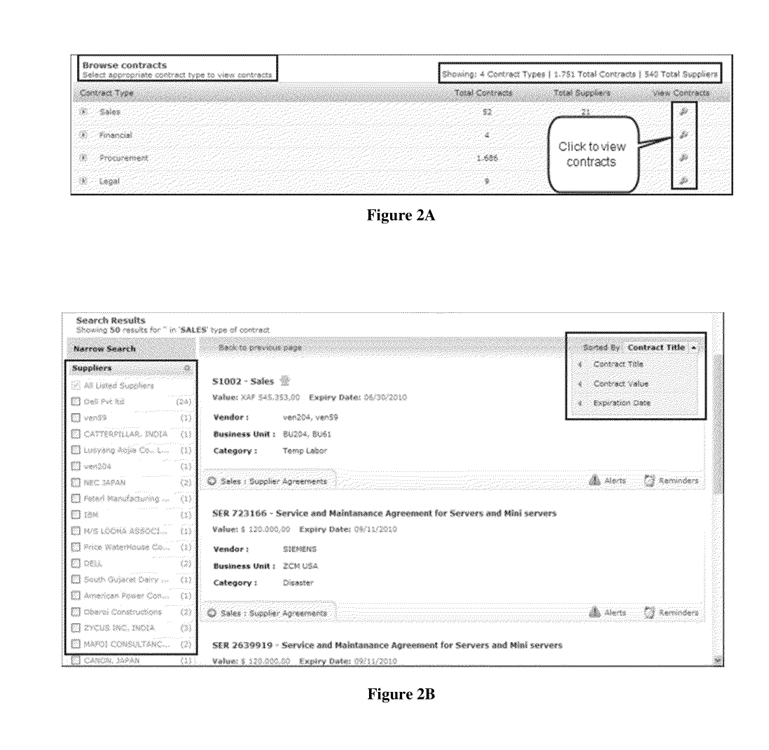

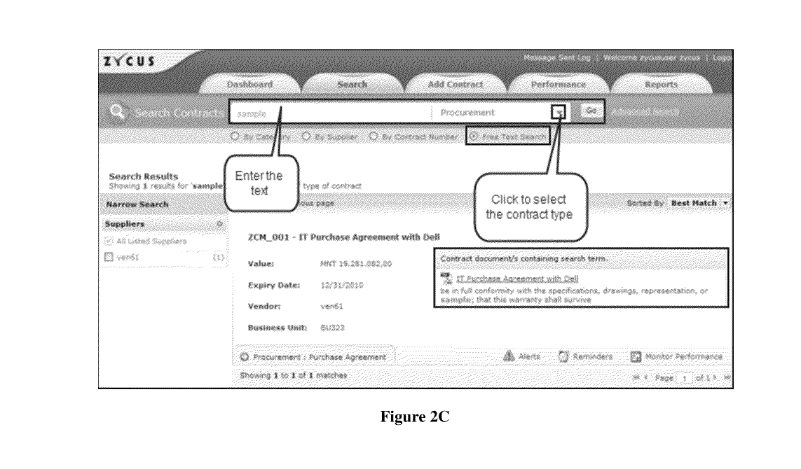

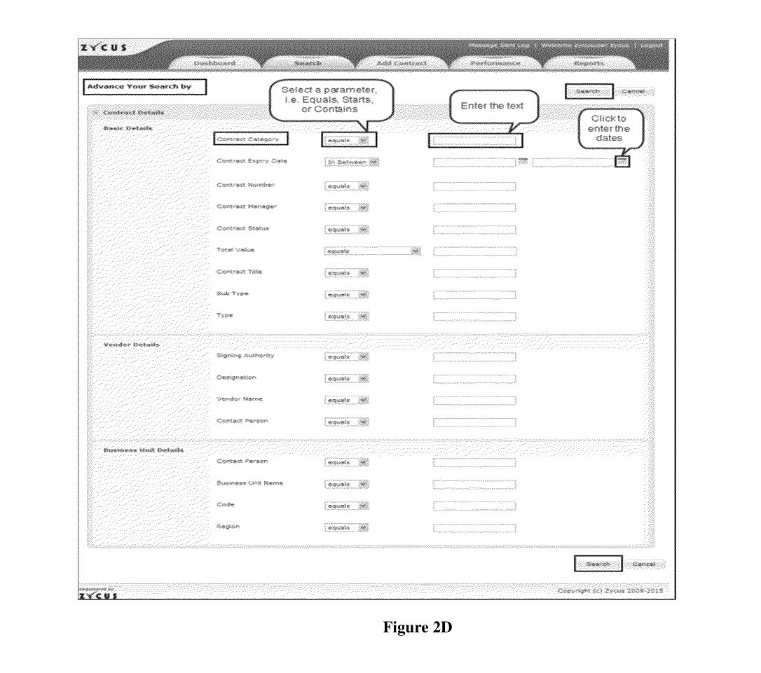

Referring to FIGS. 2a-2d, the contract module of the system contains a database of contracts of various suppliers. The contract module is intended to provide for the creation of a new contract based on a template and storing the contract in the database. It is further intended to provide for searching the contract in the database. The present invention facilitates the viewing of the supplier performance report which may be stored in the SPM module corresponding to the specific contract being selected for an action.

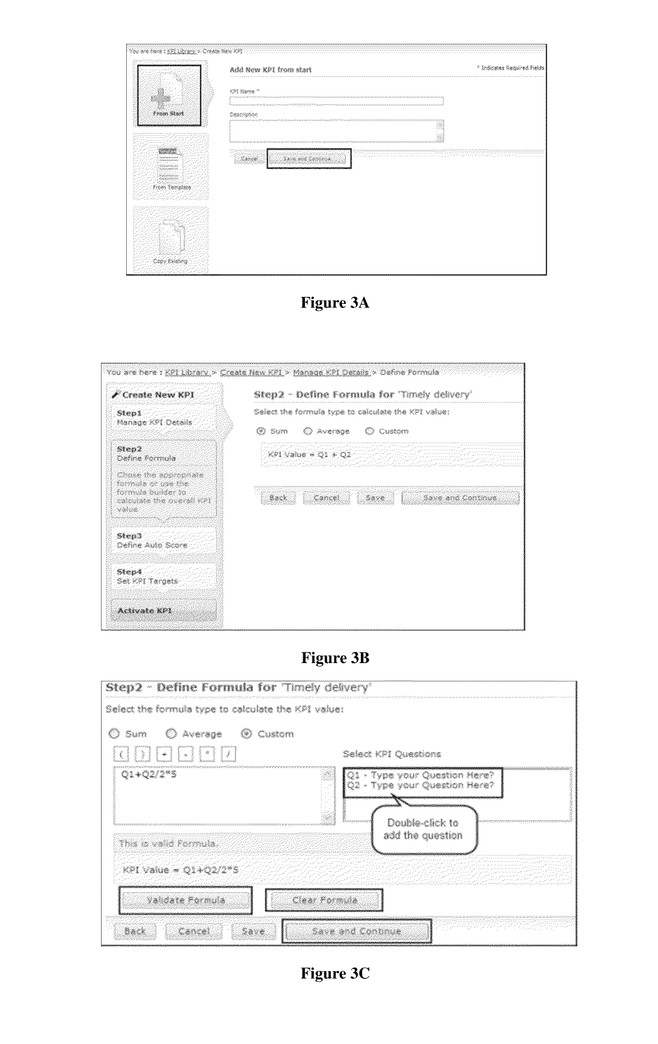

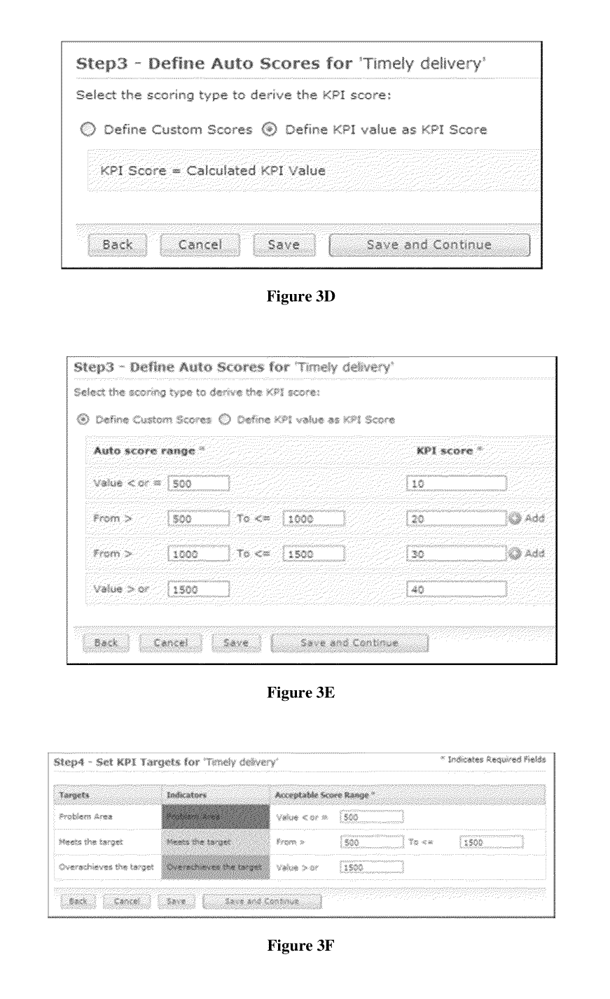

Referring to FIGS. 3a-3f, the SPM module is intended to provide for the measuring, analyzing and/or managing of the performance of the supplier in an order to reduce the costs and risks of procurement, thus aiding continuous improvement of the supplier's performance. The SPM module is intended to provide for measuring the performance of the supplier by: (1) creating metrics or key performance indicators (“KPIs”); and (2) measuring the performance against those metrics. Thus, the system helps in continuous improvement of the supplier's performance. KPIs may be a set of questions capturing the scores pertaining to the supplier for these questions which can be directed to quality, delivery time, and/or the like. The SPM module is further intended to provide for identifying potential issues and their root causes which can then be resolved.

In still another embodiment of the present invention, the system further includes an alert system for generating an alert depending on the score of the supplier's performance. By way of a non-limiting example, if the supplier scores below (or above) a threshold score, an alert can be transmitted or otherwise communicated to the user. In this manner, the user can easily identify a supplier that is performing poorly, as well as identify a supplier that has outstanding performance.

By way of a non-limiting example, the system may be adapted for mapping of specific KPIs of the supplier in the SPM module based on the type of alert generated by the system. For example, if alert is given by the contract module pertaining to an expiration period of the contract, then it may be mapped to the overall performance report. If an alert is given for a payment milestone, then it may be mapped to a quality report or to the KPIs showing the quality report scores of the supplier.

In another embodiment of the present invention, the SPM module includes a system containing decision rules, which may link to contract clauses based on the level of performance indicated in the supplier performance report. Thus it may be adapted to link to a termination clause and/or penalty clause in the contract of the supplier showing poor, average or good performance level in the supplier performance report. It may be further adapted to link to a renewal clause in the contract of the supplier showing high performance level in the supplier performance report.

In still another embodiment of the present invention, the SPM module may measure the performance of supplier by defining KPIs and associating these KPIs with a scorecard. It also facilitates the creation of new KPIs and/or modification of the existing KPIs and to assign new scores.

In accordance with another embodiment of the present invention, the flow of the above-described systems and methods will now be described. Mobile devices may upload external contract documents within the system as an attachment. Next, the external template document may be converted into a format of extracted clauses of the contract format (this conversion aids the system to understand what are the contents/clauses of the contract).

In one embodiment of the present invention, the extracted information may be presented to the user in a classified form. As shown in commonly owned U.S. patent application Ser. No. 14/588,591, the entire specification of which is expressly incorporated herein by reference, the structure of the contract that may be extracted or interpreted as described above, may be presented in the form of a tree structure, wherein the method facilitates the user to review the extracted information. It may provide for the user the opportunity to review the classification of text, rectify any misclassified text, assign a category to unclassified text and/or the like.

With respect to system mapping the contract clauses to various degrees/levels of supplier performance, system triggering compliance alerts to the input output devices may be provided, e.g., as an extract of those particular contract clauses based on the degree of supplier performance resulting into those triggers. For example, the user through the input/output devices may take any necessary action by deciding between the action modules comprised of: a) recommendation module sending recommendations to the supplier for corrective measures for improving an underperforming supplier; and b) a penalty module sending necessary directions to the procurement department for charging a penalty or terminating the supplier.

Through this system, the recommendation may be required to be sent by the vendor management team and may be selected from the recommendation database.

Through the system, e.g., from the recommendation database, the recommendation may be selected by a correlation between problem areas and/or hypothesis. By this correlation, a list of suitable recommendations may be pulled out from the database of recommendations stored therein.

Through the system, the recommendation sent to the supplier may be either accepted or rejected. If accepted by the supplier to work upon, then a track record may be maintained in the recommendation database for the adherence to the recommendation.

If any performance level is reduced by the supplier below a certain level, the different performance criteria of the supplier may be tied to various contract clauses for sending alerts as extracts of the requisite contract clauses. For example, in a contract there could be a penalty clause tied to the delay in the delivery schedule. For example, the performance level of supplier X may be monitored on the delivery criteria having different levels such as: delivery time equals 3 days is excellent; delivery time equals 5 days is satisfactory; and delivery time equals 7 days is below standard.

For the delivery time of 7 days, which would be below standard, this would be tied to the requisite penalty clause of that supplier's contract. For example, with respect to the penalty clause in the contract, if the delivery time is less than 6 days, then the supplier would pay 5% of the purchase values as a credit (e.g., per a service level agreement (“SLA”)) to the purchaser. In this system, as and when the supplier performance is updated relating to delivery time as 7 days, the integrated system with the contract database may send an alert as a requisite penalty clause, mentioning that the penalty amount needs to be charged.

Thus, the purchasing department may impose a penalty and/or recover a penalty from the supplier. Further, continuing with this example, if the delivery time is 10 days for three consecutive delivery cycles, then the system may trigger a termination clause of the contract as an alert, because this low standard of delivery performance of the vendor could have been tied to the termination clause of the contract, instead of an imposition of a penalty.

Thus, this integrated system allows for contract clause level mapping versus the supplier's degree of performance.

In some applications, the present invention described above may be provided as elements of an integrated software system, in which the features may be provided as separate elements of a computer program. Some embodiments may be implemented, for example, using a computer-readable storage medium (e.g., non-transitory) or article which may store an instruction or a set of instructions that, if executed by a processor, may cause the processor to perform a method in accordance with the embodiments. Other applications of the present invention may be embodied as a hybrid system of dedicated hardware and software components. Moreover, not all of the features described above need be provided or need be provided as separate units. Additionally, it is noted that the arrangement of the features do not necessarily imply a particular order or sequence of events, nor are they intended to exclude other possibilities. For example, the features may occur in any order or substantially simultaneously with each other. Such implementation details are immaterial to the operation of the present invention unless otherwise noted above.

The exemplary methods and computer program instructions may be embodied on a computer readable storage medium (e.g., non-transitory) that may include any medium that can store information. Examples of a computer readable storage medium (e.g., non-transitory) include electronic circuits, semiconductor memory devices, ROM, flash memory, erasable ROM (EROM), floppy diskette, CD-ROM, optical disk, hard disk, fiber optic medium, or any electromagnetic or optical storage device. In addition, a server or database server may include computer readable media configured to store executable program instructions. The features of the embodiments of the present invention may be implemented in hardware, software, firmware, or a combination thereof and utilized in systems, subsystems, components or subcomponents thereof.

Furthermore, a software program embodying the features of the present invention may be used in conjunction with a computer device or system. Examples of a computing device or system may include, but are not limited to, an electronic book reading device, a computer workstation, a terminal computer, a server computer, a handheld device (e.g., a tablet computer, a personal digital assistant “PDA”, a mobile telephone, a Smartphone, etc.), a web appliance, a network router, a network switch, a network bridge, any machine capable of executing a sequence of instructions that specify an action to be taken by that machine, and any combinations thereof. In one example, a computing device may include and/or be included in, a kiosk.

The computer device or system may also include an input device. In one example, a user of the computer device or system may enter commands and/or other information into computer device or system via an input device. Examples of an input device may include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. The input device may be interfaced to bus via any of a variety of interfaces including, but not limited to, a serial interface, a parallel interface, a game port, a USB interface, a FIREWIRE interface, a direct interface to bus, and any combinations thereof. The input device may include a touch screen interface that may be a part of or separate from the display.

A user may also input commands and/or other information to the computer device or system via a storage device (e.g., a removable disk drive, a flash drive, etc.) and/or a network interface device. A network interface device, such as network interface device may be utilized for connecting the computer device or system to one or more of a variety of networks and/or one or more remote devices connected thereto. Examples of a network interface device may include, but are not limited to, a network interface card (e.g., a mobile network interface card, a LAN card), a modem, and any combination thereof. Examples of a network may include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software, etc.) may be communicated to and/or from the computer device or system via a network interface device.

The computer device or system may further include a video display adapter for communicating a displayable image to a display device, such as a display device. Examples of a display device may include, but are not limited to, a liquid crystal display (LCD), a cathode ray tube (CRT), a plasma display, a light emitting diode (LED) display, and any combinations thereof. In addition to a display device, the computer device or system may include one or more other peripheral output devices including, but not limited to, an audio speaker, a printer, and any combinations thereof. Such peripheral output devices may be connected to a bus via a peripheral interface. Examples of a peripheral interface may include, but are not limited to, a serial port, a USB connection, a FIREWIRE connection, a parallel connection, and any combinations thereof.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for taking action based on supplier contract and performance, wherein there is an interconnection of at least one configurable and namable business process element, comprising:
a host computer system;
at least one database component associated with the host computer system;
a communication interface for accessing the host computer system from a plurality of remote input/output devices to manage action based on a supplier contract and performance for the business process element;
a processor unit operably associated with the host computer system; and
a computer readable medium storing instructions executable by the processor unit, the computer readable medium comprising:
a contract module containing a database of supplier contracts; and
a supplier performance module operably associated with the contract module;
wherein the supplier performance module is adapted for measuring, analyzing and/or managing the performance of a supplier;
wherein the system is adapted for analyzing and taking actions pertaining to contracts and supplier's performance in a procurement process;
wherein the system is adapted for viewing a supplier performance report corresponding to a specific contract selected for an action;
wherein the system is adapted for viewing the contracts and its clauses based on a level of performance corresponding to a specific supplier.

2. The system according to claim 1, wherein, the supplier performance module measures the performance of the supplier by defining key performance indicators and associating the key performance indicators with a scorecard, wherein the key performance indicators are a set of questions capturing the scores pertaining to the supplier for these questions.

3. The system according to claim 1, wherein the system further comprises an alert system for generating an alert depending on the score of the supplier's performance.

4. The system according to n claim 1, wherein the system is adapted for mapping of specific key performance indicators of the supplier in the supplier performance module based on the type of alert generated by the system.

5. The system according to claim 1, wherein the supplier performance module comprises a system containing decision rules which link to contract clauses based on the level of performance indicated in the supplier performance report.

6. The system according to claim 5, wherein the system contains decision rules adapted to link to a termination clause and/or penalty clause in the contract of a supplier showing a poor, average and/or good performance level in the supplier performance report.

7. The system according to claim 5, wherein the system contains decision rules adapted to link to a renewal clause in the contract of the supplier showing a high performance level in the supplier performance report.

8. The system according to claim 2, wherein the supplier performance module facilitates the creation of new key performance indicators and/or modification of existing key performance indicators, wherein the supplier performance module further facilitates the assignment of new scores.

9. A method for taking action based on supplier contract and performance, wherein there is an interconnection of at least one configurable and namable business process element, comprising the steps of:
providing a host computer system;
providing at least one database component associated with the host computer system;
providing a communication interface for accessing the host computer system from a plurality of remote input/output devices to manage action based on a supplier contract and performance for the business process element;
providing a processor unit operably associated with the host computer system; and
providing a computer readable medium storing instructions executable by the processor unit to perform the steps of:
creating a database of contracts of suppliers or adding contracts of suppliers to the existing database in a contract module; and
measuring, analyzing and/or managing the performance of a supplier in a supplier performance module;
wherein the method is adapted for viewing a supplier performance report corresponding to the specific contract being selected for an action;
wherein the method is adapted for viewing contracts and its clauses based on the level of performance corresponding to the specific supplier being selected.

10. The method according to claim 9, wherein the supplier performance module measures the performance of a supplier by defining key performance indicators and associating the key performance indicators with a scorecard, wherein the key performance indicators are a set of questions capturing the scores pertaining to the supplier for these questions.

11. The method according to claim 9, further comprising the step of generating an alert depending on the score of the supplier's performance.

12. The method according to claim 9, wherein the method is adapted for mapping of specific key performance indicators of the supplier in the supplier performance module based on the type of alert generated by the system.

13. The method according to claim 9, further comprising the step of creating decision rules which link to contract clauses based on the level of performance indicated in the supplier performance report.

14. The method according to claim 13, wherein the step of creating decision rules is adapted to link to a termination clause and/or penalty clause in the contract of the supplier showing poor, average or good performance levels in the supplier performance report.

15. The method according to claim 13, wherein the step of creating decision rules is adapted to link to a renewal clause in the contract of the supplier showing high performance level in the supplier performance report.

16. The method according to claim 10, wherein the method facilitates the creation of new key performance indicators and/or the modification of existing key performance indicators, wherein the method further facilitates the assignment of new scores.
